(19) United States
(12) Patent Application Publication
(10) Pub. No.: US 2018/0101156 A1
(43) Pub. Date: Apr. 12, 2018

(54) ENERGY LIMITING BARRIER FOR UNIVERSAL IO IN INTRISICALLY SAFE INDUSTRIAL APPLICATIONS

(71) Applicant: Honeywell International Inc., Morris Plains, NJ (US)

(72) Inventors: Dinesh Kumar KN, Bangalore (IN); Sai Krishnan Jagannathan, Bangalore (IN)

(21) Appl. No.: 15/287,180

(22) Filed: Oct. 6, 2016

(51) Int. Cl. G05B 19/042; G05B 23/02

(52) U.S. Cl. CPC G05B 19/0425; G05B 2219/32021; G05B 2219/1195; G05B 23/0213

(57) ABSTRACT

An apparatus includes one or more channels. Each channel includes circuitry configured to receive an input current from a universal input/output (UIO) and provide an output to a field device in a hazardous or potentially hazardous zone, the circuitry further configured to limit energy to the field device by limiting at least one of a voltage, a current, or a power of the output. Each channel also includes terminals configured to connect the circuitry to one or more cables coupling the field device to the apparatus. Each channel is configured to provide an intrinsically safe barrier between the field device and a controller that controls operation of the field device.

### TECHNICAL FIELD

This disclosure relates generally to industrial process control and automation systems. More specifically, this disclosure relates to an energy limiting barrier for a universal IO in intrinsically safe industrial applications.

### BACKGROUND

Industrial process control and automation systems are often used to automate large and complex industrial processes. These types of systems routinely include various components including sensors, actuators, and controllers. Some of the controllers can receive measurements from the sensors and generate control signals for the actuators.

Existing process control and automation systems typically have hardware components participating in control and input/output (I/O) functions that are installed in a control room. These systems are often used to gather I/O information from the field, which is transmitted to the control room. The systems in the control room can perform various control functions and transmit outputs back to the field.

In hazardous environments, it may be necessary or desirable to energy limit and isolate critical I/O functions using an intrinsically safe barrier. Intrinsic safety (IS) is a protection technique for safe operation of electrical equipment in hazardous areas by limiting the electrical or thermal energy available for ignition. This is typically achieved through the use of one or more IS barriers.

### SUMMARY

This disclosure provides an energy limiting barrier for an energy limiting barrier for a universal IO in intrinsically safe industrial applications.

In a first embodiment, an apparatus includes one or more channels. Each channel includes circuitry configured to receive an input current from a universal input/output (UIO) and provide an output to a field device in a hazardous or potentially hazardous zone, the circuitry further configured to limit energy to the field device by limiting at least one of a voltage, a current, or a power of the output. Each channel also includes terminals configured to connect the circuitry to one or more cables coupling the field device to the apparatus. Each channel is configured to provide an intrinsically safe barrier between the field device and a controller that controls operation of the field device.

In a second embodiment, a system includes a UIO and an intrinsically safe (IS) barrier coupled to the UIO. The IS barrier includes one or more channels. Each channel includes circuitry configured to receive an input current from the UIO and provide an output to a field device in a hazardous or potentially hazardous zone, the circuitry further configured to limit energy to the field device by limiting at least one of a voltage, a current, or a power of the output. Each channel also includes terminals configured to connect the circuitry to one or more cables coupling the field device to the IS barrier. Each channel is configured to provide an intrinsically safe barrier between the field device and a controller that controls operation of the field device.

In a third embodiment, a method includes receiving, by an IS barrier, an input current from a UIO. The method also includes providing, by the IS barrier, an output to a field device in a hazardous or potentially hazardous zone. The method further includes limiting energy to the field device by limiting at least one of a voltage, a current, or a power of the output. The IS barrier includes one or more channels, each channel comprising terminals configured to connect the IS barrier to one or more cables coupling the field device to the IS barrier.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a portion of an example industrial process control and automation system according to this disclosure;

FIG. 2 illustrates an example system in which an intrinsically safe (IS) barrier is used with a universal input/output (UIO) according to this disclosure;

FIG. 3 illustrates an example system in which an IS barrier is integrated with a UIO according to this disclosure;

FIG. 4 illustrates an example device for use with an IS barrier and a UIO in a distributed control system according to this disclosure; and

FIG. 5 illustrates a method for using an IS barrier and a UIO in a distributed control system according to this disclosure.

### DETAILED DESCRIPTION

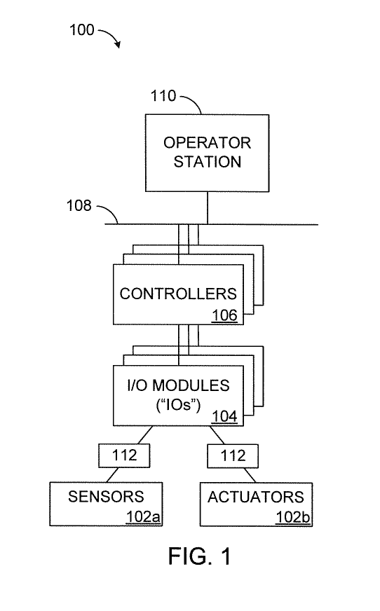

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates a portion of an example industrial process control and automation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials or energy in different forms in some manner.

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module (sometimes referred to simply as “IO”) 104 is coupled to the sensors 102a and actuators 102b. The IOs 104 facilitate interaction with the sensors 102a, actuators 102b, or other field devices. For example, an IO 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each IO 104 includes any suitable structure(s) for receiving one or more input signals from or providing one or more output signals to one or more field devices.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the IO(s) 104. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a WINDOWS operating system, or other operating system.

Operator access to and interaction with the controllers 106 and other components of the system 100 can occur via various operator stations 110. Each operator station 110 could be used to provide information to an operator and receive information from an operator. For example, each operator station 110 could provide information identifying a current state of an industrial process to an operator, such as values of various process variables and warnings, alarms, or other states associated with the industrial process. Each operator station 110 could also receive information affecting how the industrial process is controlled, such as by receiving setpoints for process variables controlled by the controllers 106 or other information that alters or affects how the controllers 106 control the industrial process. Each operator station 110 includes any suitable structure for displaying information to and interacting with an operator.

This represents a brief description of one type of industrial process control and automation system that may be used to manufacture or process one or more materials. Additional details regarding industrial process control and automation systems are well-known in the art and are not needed for an understanding of this disclosure. Also, industrial process control and automation systems are highly configurable and can be configured in any suitable manner according to particular needs.

In particular embodiments, the various controllers and operator stations in FIG. 1 may represent computing devices. For example, each of the controllers and operator stations could include one or more processing devices and one or more memories for storing instructions and data used, generated, or collected by the processing device(s). Each of the controllers and operator stations could also include at least one network interface, such as one or more Ethernet interfaces or wireless transceivers.

In process control and automation systems such as the system 100, I/O channels are used to connect controllers (such as the controller 106) and field devices (such as the sensors 102a and actuators 102b). In general, IOs 104 can support I/O channels of various types, including analog inputs (AIs), digital inputs (DIs), digital input sequences of events (DISOEs), pulse accumulator inputs (PIs), analog outputs (AOs), or digital outputs (DOs). Different I/O channel types are characterized by different inputs, outputs, voltages, currents, and configurations. For example, AI and AO channels are typically of the 4-20 mA type, but they could also include thermocouples and the like. In contrast, DI and DO channels typically include other configurations.

A universal I/O (UIO) channel is a specialized I/O channel that is reconfigurable to operate as any of multiple I/O channel types. Example types of UIO circuits are shown in U.S. Pat. No. 8,072,098; U.S. Pat. No. 8,392,626; U.S. Pat. No. 8,656,065; and U.S. Patent Publication No. 2015/0278144 (all of which are hereby incorporated by reference in their entirety). UIO circuits that support UNIVERSAL CHANNEL TECHNOLOGY available from HONEYWELL INTERNATIONAL INC. are also suitable for use.

A UIO channel could have a current output in various configurations, regardless of the I/O type of the field device to which the UIO channel is connected. Often times, the current output is used to measure a corresponding signal. As discussed above, it may be necessary or desirable in some systems to utilize intrinsically safe (IS) barriers to achieve intrinsic safety where hazardous or potentially hazardous conditions may exist. Existing IS barriers are available for use in conjunction with I/O channels, but most IS barriers are configured for use with an I/O channel of a particular I/O type (such as AI or DO).

An IO supporting one or more UIO channels (referred to as a “UIO module” or simply a “UIO”) may use one or more external IS barriers to interface to field devices in hazardous or potentially hazardous locations. In systems that utilize UIOs, low-cost IS barriers that can be installed in the field close to the terminal modules may be an important or critical requirement. However, the use of currently-available third party barriers can be complex and cost prohibitive. In some instances, for example, each IS barrier can cost upwards of $60 to $70 per channel, which can be problematic when there are numerous I/O channels to be protected. Also, existing IS barriers may require additional cabinets for installation, which further increases the size and cost of the implementation.

In accordance with this disclosure, various components in the system 100 could be designed or modified to support an IS energy limiting barrier for use with a UIO. For example, one or more of the sensors 102a and actuators 102b could be disposed in a hazardous or potentially hazardous zone, while one or more of the controllers 106 could be implemented in a safe zone. Moreover, an IO 104 may be used to connect one or more of the controllers 106 and one or more of the sensors 102a and actuators 102b. In some embodiments, the IO 104 represents a UIO. An IS barrier 112 may be positioned between the IO 104 and one or more of the sensors 102a and actuators 102b to ensure intrinsic safety. Additional details regarding the IO 104 and the IS barrier 112 are provided below.

Although FIG. 1 illustrates one example of an industrial process control and automation system 100, various changes may be made to FIG. 1. For example, the system 100 could include any number of sensors, actuators, I/O modules, controllers, operator stations, networks, IS barriers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment in which an IS energy limiting barrier can be used with a UIO. This functionality can be used in any other suitable system, and the system need not be related to industrial process control and automation.

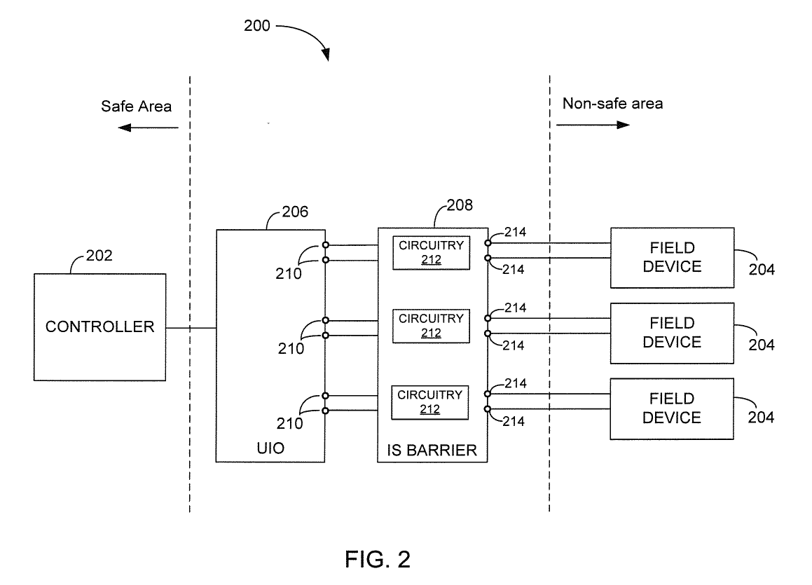

FIG. 2 illustrates an example system 200 in which an IS barrier is used with a UIO according to this disclosure. The system 200 may actually denote a portion of the system 100 shown in FIG. 1. However, the system 200 could be used as part of any other suitable larger system.

As shown in FIG. 2, the system 200 includes a controller 202, field devices 204, a UIO module 206, and an IS barrier 208. The controller 202 includes any suitable control system hardware (or combination of hardware and software/firmware) for interacting with or controlling one or more of the field devices 204. The controller 202 could, for example, represent a multivariable controller, such as a RMPCT controller or other type of controller implementing MPC or APC. As a particular example, the controller 202 could represent one of the controllers 106 of FIG. 1.

The field devices 204 represent any suitable structures for measuring one or more characteristics in a process system, operating on or affecting one or more conditions in a process system, or performing other functions in a process system. The field devices 204 could represent one or more of the sensors 102a and actuators 102b of FIG. 1. As shown in FIG. 2, the field devices 204 are disposed in a hazardous or potentially hazardous area, such as an area with a Zone 0 or Zone 1 classification. In contrast, the controller 202 is disposed in a safe zone, such as in a control room.

The UIO 206 is coupled between the controller 202 and the IS barrier 208. The UIO 206 is a programmable channel circuit that includes UIO channels and bi-directional I/O terminals 210. In some embodiments, the UIO 206 can automatically select one of multiple modes for each channel depending on the I/O type of the field device 204 connected to the corresponding UIO channel. One characteristic of the UIO 206 is that, regardless of the I/O type of the field device 204, the UIO 206 provides a current output. That is, in contrast to some IOs that generate or process a voltage output, the UIO 206 can provide a current output regardless of the I/O type of the associated field device 204. While the UIO 206 is shown here as having three I/O channels and three corresponding pairs of I/O terminals 210, this is for example purposes only. Other embodiments of the UIO 206 may contain more or fewer UIO channels.

The IS barrier 208 is coupled between the UIO 206 and the field devices 204. The IS barrier 208 includes a plurality of channels. Each channel includes circuitry 212 and screw terminals 214. Each channel is associated with a corresponding field device 204. The screw terminals 214 connect the circuitry 212 to one or more I/O cables that are coupled to the IS barrier 208. The I/O cables extend to the field devices 204, thereby coupling the field devices 204 to the channels of the IS barrier 208.

Among other things, the IS barrier 208 supports a simplified design that supports current output only. As discussed earlier, the UIO 206 provides a current output function for all I/O types that are supported by the UIO 206. The IS barrier 208 leverages the all-current-output nature of the UIO 206. In contrast, any IS barrier design that supported one or more combinations of current/voltage inputs or outputs would be unnecessarily complex and expensive.

In some embodiments, the IS barrier 208 includes only two screw terminals 214 for each channel. This is in contrast to other IS barriers that are usable with the UIO 206 but include four or more screw terminals. Use of these other types of IS barriers results in some loss of the universality of the UIO 206. For example, IS barriers with four or more screw terminals often must be programmed or configured differently (or different combinations of screw terminals must be used) depending on the I/O type of the signal that is to be carried. This represents a significant temporal or pecuniary cost for implementation and maintenance. Because the IS barrier 208 includes only two screw terminals 214 for each channel, no reconfiguration or reprogramming is required to accommodate field devices of different I/O types. The IS barrier 208 uses only the two screw terminals 214 per channel regardless of the I/O type of the field device 204. In some embodiments, one of the two screw terminals 214 is always connected to ground, and the other screw terminal 214 carries a live signal.

The circuitry 212 of each channel limits the energy output between the UIO 206 and the field device 204 corresponding to that channel. For example, the circuitry 212 of each channel can limit output current, voltage, power, or a combination of these. While the IS barrier 208 is configured to limit energy regardless of the I/O type of the connected field devices 204, the circuitry 212 of each channel does not require any mechanical reconfiguration, software reconfiguration, or any other type of reconfiguration to limit energy output when a different field device having a different I/O type is coupled to the same channel. For example, if an AO field device 204 is connected to one channel of the IS barrier 208, the IS barrier 208 can operate as an energy limiting barrier for the AO field device 204. Later, if the AO field device 204 is disconnected and a DI field device 204 is connected in its place, the IS barrier 208 can still operate as an energy limiting barrier for the DI field device 204 without any mechanical or software reconfiguration of the circuitry 212 for that channel.

The circuitry 212 can include any suitable structure or components for achieving the energy limiting function of the IS barrier 208. For example, the circuitry 212 can include passive circuit elements, active circuit elements, or a combination of the two. Passive circuit elements include, but are not limited to, resistors, capacitors, inductors, transformers, Zener diodes, and the like. Active circuit elements include, but are not limited to, transistors, silicon-controlled rectifiers (SCRs), and the like. In a passive system, current at the input of the circuitry 212 is received and then limited by one or more passive circuit elements before the current is output. In an active system where the input current is completely isolated from the output current, the input signal is actively monitored and replicated at a safe current level at the output side.

In some embodiments, the IS barrier 208 is an energy limiting barrier without any galvanic isolation function. In other embodiments, the IS barrier 208 includes galvanic isolation as well as operating as an energy limiting barrier. Also, in some embodiments, the IS barrier 208 and the UIO 206 are positioned very close to the controller 202 so that there is a safe I/O area outside the control room.

Although FIG. 2 illustrates one example of a system 200 in which an IS barrier is used with a UIO, various changes may be made to FIG. 2. For example, various components in FIG. 2 could be combined, further subdivided, or omitted and additional components could be added according to particular needs. Also, process control and automation systems can come in a wide variety of configurations, and FIG. 2 does not limit this disclosure to any particular configuration.

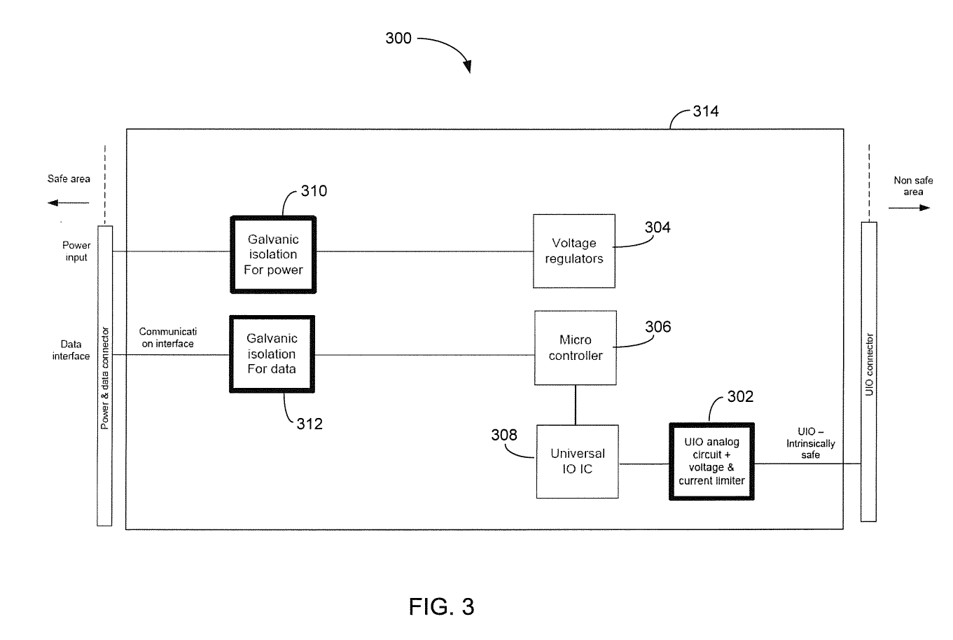

FIG. 3 illustrates an example system 300 in which an IS barrier is integrated with a UIO according to this disclosure. The system 300 can include one or more components in common with the system 200 of FIG. 2 and may be used in the systems 100 and 200 of FIGS. 1 and 2. However, the system 300 could be used as part of any other suitable larger system.

As shown in FIG. 3, the system 300 includes components of an IS barrier that are integrated with a UIO in a single enclosure. In particular, the system 300 includes a voltage and current limiter module 302, one or more voltage regulators 304, one or more controllers 306, one or more UIO integrated circuits 308, and one or more galvanic isolation modules 310-312. A housing 314 encloses all of these components 302-312.

The voltage and current limiter module 302 provides voltage, current, and power limiting functions similar to the energy limiting functions of the IS barrier 208 of FIG. 2. Galvanic isolation for power and galvanic isolation for data can be performed by the galvanic isolation modules 310-312, which are separate from each other and separate from the voltage and current limiter module 302. In general, galvanic isolation and intrinsic safety functions can be distributed with an I/O system. The voltage regulator(s) 304 operate to regulate the overall power voltage of the system 300. The controller(s) 306 perform various functions in order to control overall operation of the system 300. The UIO integrated circuit(s) 308 include circuitry elements to perform IO functions for the system 300. The voltage regulator(s) 304, controller(s) 306, and UIO integrated circuit(s) 308 can also be distributed, but together can operate in a manner similar to the UIO 206 of FIG. 2.

Although FIG. 3 illustrates one example of a system 300 in which an IS barrier is integrated with a UIO, various changes may be made to FIG. 3. For example, various components in FIG. 3 could be combined, further subdivided, or omitted and additional components could be added according to particular needs. Also, process control and automation systems can come in a wide variety of configurations, and FIG. 3 does not limit this disclosure to any particular configuration.

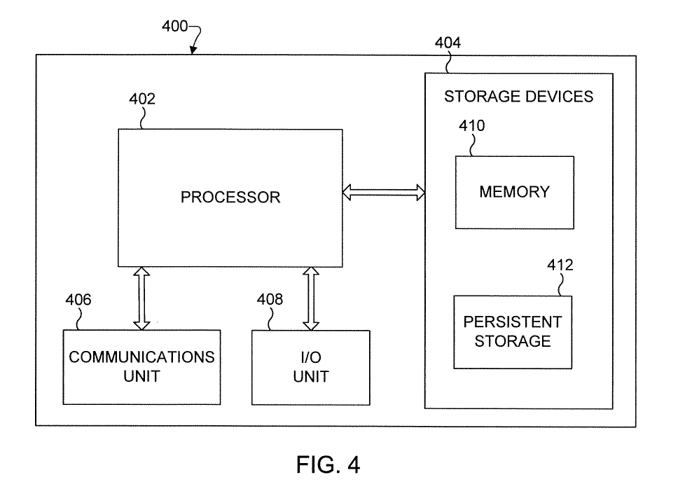

FIG. 4 illustrates an example device 400 for use with an IS barrier and a UIO in a distributed control system according to this disclosure. The device 400 could, for example, represent a computing device in the system 100 of FIG. 1, such as one of the controllers 106 or one of the operator stations 110. As another example, various components of the device 400 could be included in the systems 200 and 300, such as in the UIO 206, the IS barrier 208, or the controller 306. The device 400 could represent any other suitable device or components for performing functions associated with an IS barrier and a UIO in a distributed control system.

As shown in FIG. 4, the device 400 includes at least one processor 402, at least one storage device 404, at least one communications unit 406, and at least one input/output (I/O) unit 408. Each processor 402 can execute instructions, such as those that may be loaded into a memory 410. Each processor 402 denotes any suitable processing device, such as one or more microprocessors, microcontrollers, digital signal processors, application specific integrated circuits (ASICs), or discrete circuitry.

The memory 410 and a persistent storage 412 are examples of storage devices 404, which represent any structure(s) capable of storing and facilitating retrieval of information (such as data, program code, and/or other suitable information on a temporary or permanent basis). The memory 410 may represent a random access memory or any other suitable volatile or non-volatile storage device(s). The persistent storage 412 may contain one or more components or devices supporting longer-term storage of data, such as a read only memory, hard drive, Flash memory, or optical disc.

The communications unit 406 supports communications with other systems or devices. For example, the communications unit 406 could include at least one network interface card or wireless transceiver facilitating communications over at least one wired or wireless network. The communications unit 406 may support communications through any suitable physical or wireless communication link(s).

The I/O unit 408 allows for input and output of data. For example, the I/O unit 408 may provide a connection for user input through a keyboard, mouse, keypad, touchscreen, or other suitable input device. The I/O unit 408 may also send output to a display, printer, or other suitable output device.

Although FIG. 4 illustrates one example of a device 400 for use with an IS barrier and a UIO in a distributed control system, various changes may be made to FIG. 4. For example, various components in FIG. 4 could be combined, further subdivided, or omitted and additional components could be added according to particular needs. Also, computing devices can come in a wide variety of configurations, and FIG. 4 does not limit this disclosure to any particular configuration.

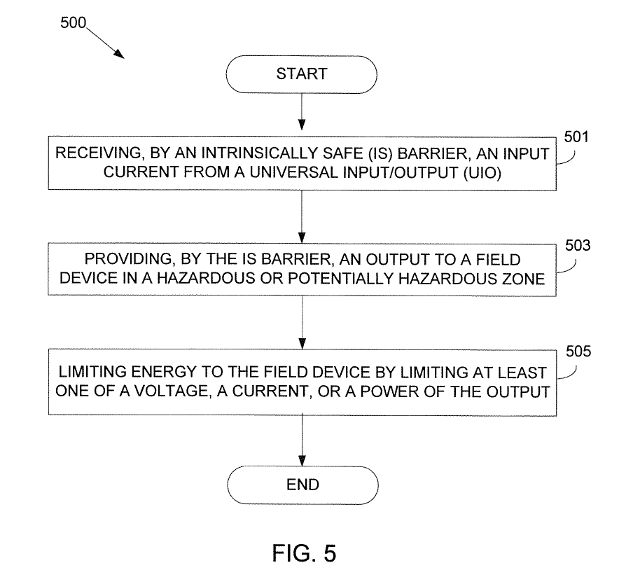

FIG. 5 illustrates an example method 500 for using an IS barrier and a UIO in a distributed control system according to this disclosure. For ease of explanation, the method 500 is described as being performed using the system 200 of FIG. 2. However, the method 500 could be used with any suitable device or system.

An IS barrier receives an input current from a UIO at step 501. This could include, for example, the IS barrier 208 receiving an all-current output from the UIO 206. In some embodiments, the IS barrier receives a current signal regardless of a type of input or output signal.

The IS barrier provides an output to a field device in a hazardous or potentially hazardous zone at step 503. This could include, for example, circuitry 212 of one of the channels of the IS barrier 208 providing an output to a field device 204 coupled to the channel.

At step 505, the IS barrier limits energy to the field device by limiting at least one of a voltage, a current, or a power of the output. This could include the IS barrier 208 limiting the energy to the field device 204 to provide a safe output.

Although FIG. 5 illustrates one example of a method 500 for using an IS barrier and a UIO in a distributed control system, various changes may be made to FIG. 5. For example, while shown as a series of steps, various steps shown in FIG. 5 could overlap, occur in parallel, occur in a different order, or occur multiple times. Moreover, some steps could be combined or removed and additional steps could be added according to particular needs. In addition, while the method 500 is described with respect to the system 200 (which itself was described with respect to an industrial process control and automation system), the method 500 may be used in conjunction with other types of devices and systems.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc, a digital video disc, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, e.g., a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
one or more channels, each channel comprising:
circuitry configured to receive an input current from a universal input/output (UIO) and provide an output to a field device in a hazardous or potentially hazardous zone, the circuitry further configured to limit energy to the field device by limiting at least one of a voltage, a current, or a power of the output; and
terminals configured to connect the circuitry to one or more cables coupling the field device to the apparatus;
wherein each channel is configured to provide an intrinsically safe barrier between the field device and a controller that controls operation of the field device.

2. The apparatus of claim 1, wherein each channel is configured to receive multiple types of input or output signals from the UIO and the field device.

3. The apparatus of claim 2, wherein each channel is configured to receive the input current from the UIO regardless of the type of input or output signal.

4. The apparatus of claim 2, wherein the same terminals are used to connect the circuitry to the one or more cables regardless of the type of input or output signal.

5. The apparatus of claim 2, wherein the circuitry of each channel is configured to limit the energy to the field device regardless of the type of input or output signal without mechanical or software reconfiguration.

6. The apparatus of claim 2, wherein the multiple types of input or output signals comprise analog input, analog output, digital input, and digital output.

7. The apparatus of claim 1, wherein the circuitry of each channel is further configured to perform galvanic isolation between the UIO and the field device.

8. The apparatus of claim 1, wherein the apparatus is integrated with the UIO in a single enclosure.

9. A system comprising:
a universal input/output (UIO); and
an intrinsically safe (IS) barrier coupled to the UIO, the IS barrier comprising one or more channels, each channel comprising:
circuitry configured to receive an input current from the UIO and provide an output to a field device in a hazardous or potentially hazardous zone, the circuitry further configured to limit energy to the field device by limiting at least one of a voltage, a current, or a power of the output; and
terminals configured to connect the circuitry to one or more cables coupling the field device to the IS barrier;
wherein each channel is configured to provide an intrinsic safety function between the field device and a controller that controls operation of the field device.

10. The system of claim 9, wherein each channel is configured to receive multiple types of input or output signals from the UIO and the field device.

11. The system of claim 10, wherein each channel is configured to receive the input current from the UIO regardless of the type of input or output signal.

12. The system of claim 10, wherein the same terminals are used to connect the circuitry to the one or more cables regardless of the type of input or output signal.

13. The system of claim 10, wherein the circuitry of each channel is configured to limit the energy to the field device regardless of the type of input or output signal without mechanical or software reconfiguration.

14. The system of claim 10, wherein the multiple types of input or output signals comprise analog input, analog output, digital input, and digital output.

15. The system of claim 9, wherein the circuitry of each channel is further configured to perform galvanic isolation between the UIO and the field device.

16. The system of claim 9, wherein the IS barrier is integrated with the UIO in a single enclosure.

17. A method comprising:
receiving, by an intrinsically safe (IS) barrier, an input current from a universal input/output (UIO);
providing, by the IS barrier, an output to a field device in a hazardous or potentially hazardous zone; and
limiting energy to the field device by limiting at least one of a voltage, a current, or a power of the output,
wherein the IS barrier comprises one or more channels, each channel comprising terminals configured to connect the IS barrier to one or more cables coupling the field device to the IS barrier.

18. The method of claim 17, further comprising:
receiving multiple types of input or output signals from the UIO and the field device.

19. The method of claim 18, wherein the IS barrier is configured to receive the input current from the UIO regardless of the type of input or output signal.

20. The method of claim 18, wherein the same terminals are used to connect the IS barrier to the one or more cables regardless of the type of input or output signal.
